(19) United States
(12) Patent Application Publication
(10) Pub. No.: US 2012/0009119 A1
(43) Pub. Date: Jan. 12, 2012

(54) METHOD AND APPARATUS FOR GENERATING HYDROGEN

(76) Inventor: Genady Gideon YAMPOLSKY, Haifa (IL)

(21) Appl. No.: 13/177,474

(22) Filed: Jul. 6, 2011

Related U.S. Application Data
(60) Provisional application No. 61/361,580, filed on Jul. 6, 2010.

(51) Int. Cl. C01B 3/08; B01J 19/00

(52) U.S. Cl. 423/657; 422/162; 422/119

(57) ABSTRACT

Disclosed is a method for generating hydrogen. The method may include introducing water bubbles into a bottom region of a vessel containing molten aluminum allowing the water bubbles to rise within the molten aluminum, expanding as they rise. The method may further include collecting hydrogen, generated in a reaction between the water bubbles and the molten aluminum, from the vessel. Also disclosed is an apparatus for generating hydrogen that may include a vessel having an internal chamber for containing molten aluminum, at least one water inlet positioned at a bottom region of the vessel, at least one hydrogen outlet positioned at a top region of the vessel to and a heating element.

### CROSS REFERENCE TO RELATED APPLICATIONS

The present invention claims the priority benefit of U.S. provisional patent application No. 61/361,580 filed on Jul. 6, 2010, which is incorporated in its entirety herein by reference.

### FIELD OF THE INVENTION

This invention is directed to a method and apparatus for generating hydrogen.

### BACKGROUND OF THE INVENTION

Aluminum, which is known have a high energy potential, reacts with oxygen exothermically as follows:

2Al+3/2O₂>>Al₂O₃

The calorimetric heat of reaction at a pressure of 1 Bar is ΔH° (298K) 404 kcal/mol. The process of aluminum oxidation generates some 31 MJ of energy per kilogram, which is 70% by weight or 200% by volume compared to gasoline. Due to the high energy content of aluminum, it is considered an appropriate candidate to serve as an energy carrier substance, replacing energy sources, such as fossil fuels, as well as energy carriers, such as electric batteries. Furthermore, aluminum, being self-passivating, non-polluting, non-dangerous and recyclable, possesses many properties that are desired from an optimal energy carrier.

However, the use of aluminum as an energy carrier is hampered by two known phenomena, the first relating to the formation of an oxidation layer on the aluminum and the second relating to the necessity of a conversion process, needed to transform the generated energy into a usable form.

When reacting aluminum with oxygen, an oxide layer of alumina (Al₂O₃) quickly forms on the surface of the aluminum, which inhabits further reaction with oxygen. The formed oxide layer film is extremely strong, both mechanically and thermally and therefore, is difficult to remove. Additionally, if the oxide layer is breached at any point, it immediately reforms, again sealing the aluminum layer and not allowing it to contact with the oxygen or the oxidizing agent. Several methods are known to breach the oxide layer formed on the aluminum surface so as to bring the aluminum into contact with the oxidizing substance. One such method comprises heating the aluminum to 2030° C. At this high temperature the oxide layer melts and enables further oxidation of the aluminum. Similarly, if the aluminum is vaporized by heating to over 2800° C., the oxidation rate is dramatically increased. However, such methods require very high temperatures and are therefore limited to a narrow range of applications, such as solid fuel rocket propulsion.

Another method for penetrating the oxide layer includes using electrical discharge in processes known as “anodizing” or “plasma electric oxidation”. Usually, such methods create a thick protection layer on the metal formed by repeated penetrating and deepening of the oxide layer with the aid of local electric discharge. Although widely used in industry, the scope of such processes is limited to creating a protective layer on the aluminum instead of utilizing the aluminum for generating energy, since most of the electric power input is eventually wasted on useless low-temperature heat.

Grinding aluminum to powder, thereby increasing its surface area and thus increasing the probability of reaction with an oxidizer, is also known in the art. Furthermore, the surface curvature of nanometric powder particle affects the oxide layer perfection and increases the probability of the reaction to a level sufficient for generating energy. Powdered aluminum, in a concentration of up to 25%, is used as an enhancer in rocket fuel. However, it cannot be used in its pure form, since the powder requires initial heating by other, more reactive, ingredients. Also, the production of nanometric powder, which is reactive enough to implement sustained burning on its own, is extremely expensive and is not considered a practical solution for an application requiring cost efficiency.

The addition of certain chemical elements to the reaction environment can create compounds that replace or weaken the oxide layer formed on the aluminum surface, thus allowing the penetration of the oxidizer through it. However, such process may result in the generation of complicated chemical compositions that are difficult to separate and recycle.

Thus, although methods for overcoming the oxide layer exist, none of them offer a practical solution for using aluminum as a fuel substitute.

Another drawback of using aluminum as an energy source is that the energy output of aluminum oxidation cannot be used directly. Specifically, the directed reaction between aluminum and oxygen yields heat and molten aluminum oxide, which quickly turns to a solid. The combination of heat and the liquid or solid oxide is difficult to transform to useful mechanical or electrical power. Therefore, there is a need for a conversion process, such as boiling the liquid by combustion heat; however, the use of a conversion process affects the efficiency of the process and therefore the attractiveness of aluminum oxidation as an energy source.

U.S. Pat. No. 7,524,342, for example, discloses a method and apparatus for generating hydrogen by reacting water and aluminum rods. However, since the aluminum is in a solid state, the formation of oxides on the surface thereof causes the disclosed method to be inefficient. Additionally, U.S. Pat. No. 7,235,226 discloses a method for generating hydrogen from fine particles of aluminum; however, as detailed above, the formation of such particles requires high energy and further, in order for the reaction to take place, there is a need for additional reactive agents.

In light of the above, there is a need in the art for a method by which aluminum can be used as an energy source, wherein the method would overcome both the oxidation layer problem described above and the necessity of the utilization of a conversion process.

### SUMMARY OF THE INVENTION

Embodiments of the present invention are directed to a method for generating hydrogen comprising:
introducing water bubbles into a bottom region of a vessel containing molten aluminum allowing the water bubbles to rise within the molten aluminum, expanding as they rise; and
collecting hydrogen, generated in a reaction between the water bubbles and the molten aluminum, from the vessel.

Additional embodiments of the present invention are directed to an apparatus for generating hydrogen, said apparatus comprising:
a vessel having an internal chamber for containing molten aluminum;
at least one water inlet positioned at a bottom region of the vessel for introducing water bubbles into a bottom region of the chamber containing the molten aluminum allowing the water bubbles to rise within the molten aluminum, expanding as they rise;
at least one hydrogen outlet positioned at a top region of the vessel for collecting hydrogen generated in a reaction between the water bubbles and the molten aluminum, from the vessel;
a heating element, for heating aluminum in solid form disposed within the chamber so as to melt it into the molten aluminum.

Additional embodiments of this invention are directed to an apparatus for generating hydrogen, said apparatus comprising:
a plurality of vessels, each vessel comprising:
an internal chamber for containing molten aluminum;
at least one water inlet positioned at a bottom region of the vessel for introducing water bubbles into a bottom region of the chamber containing the molten aluminum allowing the water bubbles to rise within the molten aluminum, expanding as they rise;
at least one hydrogen outlet positioned at a top region of the vessel for collecting hydrogen generated in a reaction between the water bubbles and the molten aluminum, from the vessel; and
a heating element, for heating aluminum in solid form disposed within the chamber so as to melt it into the molten aluminum;
wherein the plurality of vessels are connected in series by way of connecting at least one hydrogen outlet of a vessel of the plurality of vessels to at least one water inlet of an adjacent vessel of the plurality of vessels.

### BRIEF DESCRIPTION OF THE DRAWINGS

FIGS. 1A-1E schematically show the progress of a reaction for generating hydrogen according to embodiments of the present invention.

FIG. 1A shows the initial contact of a water vapor bubble with molten aluminum;

FIG. 1B shows the heating of the bubble by the molten aluminum and the heat of the reaction;

FIG. 1C shows the expansion of the bubble and the tearing of the alumina layer on the surface of the bubble;

FIG. 1D shows the reaction of the newly exposed vapor with the molten aluminum;

FIG. 1E shows splitting of the bubble into several bubbles, each of which continues to react with the molten aluminum.

FIG. 2 shows a cross sectional view of an apparatus for generating hydrogen according to embodiments of the present invention.

FIG. 3 shows a cross sectional view of an apparatus comprising a series of vessels for generating hydrogen according to embodiments of the present invention.

FIG. 4 shows a cross sectional view of a nozzle for providing multiple streams of water bubbles.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

According to embodiments of the present invention, molten aluminum is contacted with droplets of water and/or bubbles of water vapor. As defined herein, water bubbles may contain water, water vapor or a mixture thereof. If water is used, the reaction conditions are set so that the water droplets first turn into vapor bubbles and then react with the molten aluminum. According to this embodiment, the temperature of the molten aluminum should be elevated, in order to compensate for the energy loss due to the phase change of water into water vapor. According to another embodiment, when using water instead of vapor, the temperature should be elevated by about 40-100° C.

Upon contact, the aluminum reacts with the water molecules, as follows:

2Al+3H₂O>>Al₂O₃+3H₂

Alumina (Al₂O₃) is created in the form of a film on the surface of the bubbles. The calorimetric heat of reaction at 1 Bar is ΔH° (298K) 230 kcal/mol and hydrogen is generated.

Due to the reaction temperature, attributed both to the temperature at which the molten aluminum is held and to the heat generated in the oxidation reaction, water vapor that remains under the alumina film heats up and expands, and may tear the alumina layer formed on the surface of the bubble, exposing additional water molecules to the molten aluminum. Another factor causing the bubbles to expand is the generation of hydrogen gas from the water vapor. Since hydrogen gas has a lower density than water vapor it tends to expand to a greater volume. The newly exposed water molecules then react with the aluminum, creating a new layer of alumina, additional hydrogen and heat, part of which further heats the bubble causing it to further expand, allowing the reaction to continue. Schematically, the water vapor may be described as going through the stages of reacting, heating, expanding, reacting, heating, expanding etc.

Once a bubble reaches a maximal size, it may separate into two or more bubbles, each of which continues to react with the molten aluminum. The reaction continues until the bubble has surfaced at the top of the molten aluminum, or until most of the vapor is consumed. According to embodiments of the present invention, for many practical uses, some 10% to 95% of the water vapor may be consumed. Once a bubble reaches the top surface of the molten aluminum the reaction of that bubble ends and the alumina that has formed around the bubble is left floating in the molten aluminum. The formed alumina is typically porous as some of the hydrogen generated by the reaction is trapped within the alumina due to the repetitive tearing and reforming of the alumina so that a layer of foamed alumina accumulates at the top region of the molten aluminum. According to an embodiment of the present invention, the alumina may be collected from the top region of the molten aluminum and may be recycled. The formed alumina is typically porous and foamed, making it easy for removal, crushing and recycling thereof.

Since the reaction ends once the bubble reaches the surface of the molten aluminum and the trapped gasses within that bubble are released into the surrounding atmosphere, the path through which the bubble travels through the molten aluminum may be designed to be long enough to allow a high percentage of the water vapor to react with the molten aluminum before the bubble reaches the top surface.

Other factors determining the reaction ratio may include (but not necessarily limited to) the temperature of the molten aluminum, turbulence within the melt, the size of the vapor bubbles and the amount of vapor introduced into the reactor. The reaction rate may increase exponentially with temperature. Further, smaller bubbles may contribute to a higher reaction rate, due to the enlargement of the total surface area of the bubbles. Additionally, intensive stirring of the melt may further contribute to the efficiency of the reaction, since stirring may lengthen the path through which the bubbles travel through the melt. According to embodiments of the invention, any of the above factors may be set so as to provide an optimal reaction ratio.

The fact that molten (liquid) aluminum (as opposed to solid aluminum) is used for the reaction with the water vapor, in accordance with embodiments of the present invention, lends itself to the ease with which the formed alumina film may be broken, since the molten aluminum which surrounds the bubble is soft, making it is easier for the bubble to expand while applying mechanical forces to tear the alumina layer. Thus, hydrogen is generated according to embodiments of this invention without the need to utilize high amounts of energy.

Additionally, the geometry created by the proposed method effectively overrides the self-supportive structure of the aluminum-oxide compound, which, under typical conditions, is chemically, mechanically and thermally stable. In contrast to conventional methods, in the proposed method force is applied on a concave, rather than a convex surface. Material tends to withstand external pressure, opposing it by contraction. However, when pressure is applied from the inside, the border of the material tends to tear, as may occur with the alumina film coating the bubbles, according to embodiments of the present invention.

According to embodiments of the present invention, the initial temperature of the molten aluminum may be higher than that of the water vapor. According to some embodiments of the invention, the initial temperature of the molten aluminum may be between about 670° C.-2000° C. According to some embodiments of the invention, the initial temperature of the molten aluminum may be about 750° C. According to some embodiments of the invention, the initial temperature of the water vapor may be between about 120° C.-2000° C. According to some embodiments, the initial temperature of the water vapor may be about 120° C.

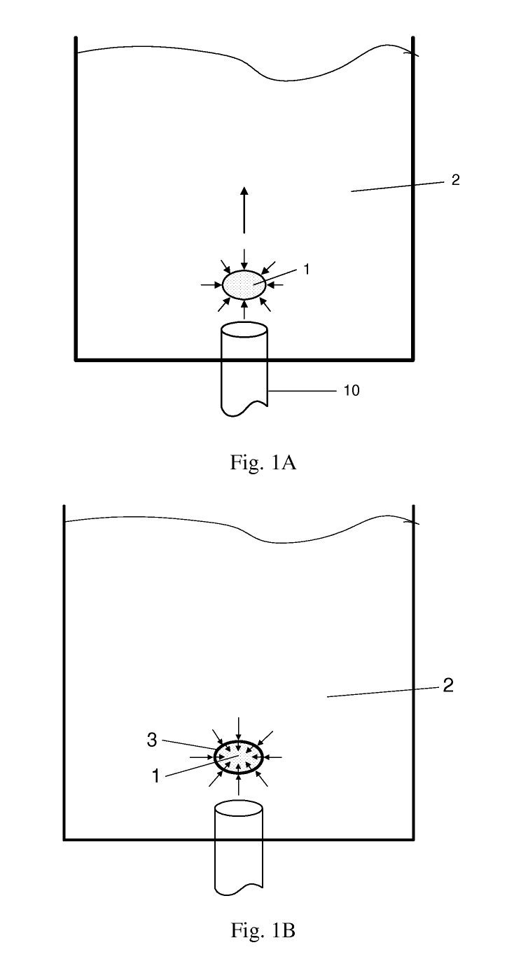

FIGS. 1A-1E schematically show the progress of a reaction for generating hydrogen according to embodiments of the present invention.

FIG. 1A shows the initial contact of a water vapor bubble (1) released from water inlet (10) with molten aluminum (2). The initial temperature of molten aluminum (2) may be higher than that of the water vapor and therefore, upon contact between bubble (1) and aluminum (2). As shown in FIG. 1B, bubble (1) is heated and water molecules on the surface thereof react with aluminum (2),creating a thin alumina layer (3), heat (not shown in figure) and hydrogen (not shown in figure). FIG. 1B additionally shows the further heating of bubble (1), both by the heat generated by the reaction between aluminum (2) and the water molecules, as well as from the surrounding molten aluminum (2) (the heat is designated in the figure as arrows). This heating, together with the hydrogen trapped in the bubble, causes the pressure inside bubble (1) to rise, thus expanding the volume thereof. As shown in FIG. 1C, the expansion of bubble (1) tears alumina layer (3) formed on the surface of bubble (1), exposing additional water molecules to aluminum (2).

FIG. 1D shows newly exposed water molecules reacting with aluminum (2), generating additional hydrogen and heat and further, a new alumina film (3) forming on the surface of expanded bubble (1). This process continues until bubble (1) has expanded to a size in which the intrinsic forces prevail and split bubble (1) into two or more bubbles (two new bubbles (4) and (5) are shown in FIG. 1E). The newly formed bubbles continue to react with the surrounding molten alumina until most of the water vapor is consumed or until the bubble reaches the surface of the molten aluminum.

A product of the reaction is hydrogen, coupled with heat and excess water vapor that emerges at the top of the molten alumina had it not reacted with the aluminum. According to certain embodiments of the invention, the hydrogen is compressed. This may be, for example, achieved by accumulating hydrogen within the vessel until a desired level of compression is obtained, before removing the hydrogen from the vessel. The generated hot compressed hydrogen may be used as a source of energy, for example, for feeding a gas turbine, which converts it to mechanical power, or for other purposes. In some embodiments both the hydrogen and the heat generated by the reaction are used as a source of energy. According to some embodiments, the excess water vapor acts as passive ballast, limiting the combustion temperature of the hydrogen to a range of about 500 to 1000° C., that is acceptable in conventional engines and turbines. According to some embodiments, the generated hot and compressed hydrogen is stored in a thermally insulated pressure vessel before delivering to an engine/turbine. The hot compressed hydrogen, carrying the thermal energy of the reaction, can then be supplied to a combustion engine or a gas turbine directly, thus efficiently substituting other forms of energy, such as gasoline. According to some embodiments, the generated hydrogen is cooled, dried and stored for further use. In other embodiments the generated hydrogen is delivered to the site at which it is to be applied.

According to embodiments of the present invention, an apparatus for generating hydrogen may include a vessel defining an internal chamber for holding molten aluminum, a water inlet located at a bottom region of the internal chamber and a hydrogen outlet located at a higher region of the chamber. The height of the internal chamber is such that, when a sufficient amount of molten aluminum is placed therein, the path that the water vapor bubbles travel through the molten aluminum is sufficiently long so that most if not all of the water vapor is consumed by the time the bubble reached the top surface of the molten aluminum, for a given amount of molten aluminum placed within the chamber. According to embodiments of the present invention, the height of the chamber and the volume of the aluminum placed therein may be designed to leave a free space above the anticipated level of the molten aluminum in which hydrogen may accumulate before it is discharged through the hydrogen outlet. When planning that free space, residue water vapor that does not interact with the molten aluminum may be taken into consideration. According to some embodiments, the accumulated hydrogen is discharged through the hydrogen outlet only after it is compressed to a desired pressure level.

According to embodiments of the invention, the water inlet may be positioned at a bottom region of the vessel so as to allow it to introduce water vapor bubbles into the molten aluminum, ensuring a sufficiently long path for the bubbles to travel within the molten aluminum as they ascend in it to the top. According to some embodiments, the water inlet may be positioned at a bottom wall of the vessel. According to some other embodiments, the water inlet may be positioned on a side wall of the vessel.

According to embodiments of the present invention, the hydrogen outlet may be positioned at a top region of the vessel, allowing the collection of the generated hydrogen. The height and volume of the molten aluminum may be planned such that the hydrogen outlet is located above the level of the molten aluminum, taking into consideration the added volume resulting from the formation of foamed alumina during the reaction between the water vapor and the molten aluminum. According to some embodiments, the hydrogen outlet may be positioned at a top surface of the vessel. According to some embodiments, the hydrogen outlet may be positioned on a side wall of the vessel.

It is noted that water vapor that did not react with the aluminum may accumulate within a top volume of the vessel and may be removed together with the collected hydrogen.

The vessel may have any appropriate shape, including a cylinder, a cube, a cuboid, etc. As the reaction of each bubble with the surrounding molten aluminum takes place along an elongated vertical path of the bubble within the molten aluminum, a vessel having an elongated vertical volume may be considered. However, some embodiments of the present invention may include a plurality of inlets placed across a bottom surface of the vessel or distributed about a bottom portion of the side wall of the vessel, such that a plurality of substantially reaction paths are formed, thus a wide vessel may be considered.

According to some embodiments, the vessel may include a cover or a stopper that is hermetically sealed, possibly including some vents for pressure equalization between the internal chamber and a hermetic envelope.

According to some embodiments, the vessel may be made from a variety of materials, such as, for example (but not limited to) high quality graphite, reinforced boron nitride, silicon nitride, alumina or alumina-silicate. According some embodiments, the vessel may be coated on the inside wall of the internal chamber with an inert material that does not react with aluminum and/or its oxide, i.e., alumina, for example, graphite, BN and Si₃N₄.

The thickness of the walls of the vessel and the material from which it is made may be selected so as to withstand both the anticipated pressure build-up resulting from the generated hydrogen and the accumulated water vapor as well as the temperature at which the molten aluminum is kept, and the temperature rise resulting from the reaction between the molten aluminum and the water molecules. According some embodiments, the vessel may include a hermetic envelope so as to enable the chamber to safely contain the generated hydrogen and the water vapor that did not react with the aluminum. According to some embodiments, the vessel may include thermal insulation.

According to an embodiment of the invention, the vessel may include, or may be placed in contact with, a heating element. The heating element may be used to provide heat to bring the molten aluminum to a desired temperature above the melting temperature of aluminum, e.g., between about 670 and 2000° C. According to further embodiments, the heating element may be used to provide heat to bring the molten aluminum to a desired temperature above the melting temperature of aluminum, e.g., 750° C. According to some embodiments, the aluminum placed in the chamber may initially be provided in a solid form (e.g. pellets, powder, wire, bars, rods, etc.). In some embodiments, the heating element may be located so as to avoid direct contact with the aluminum. The heating element may be deactivated later or set to output less power when the reaction is underway. Excess heat may be removed together with the hydrogen.

In some embodiments the vessel may be provided with a cooling system, such as, for example, air or water cooling systems, which prevents overheating of the apparatus. In some embodiments, the cooling system may be coupled with a system for utilizing at least part of the heat generated by the reaction between the water vapor and the aluminum. According to some embodiments, the vessel may be cooled by a water cooling system, wherein the water in the cooling system is converted into steam by the heat of the reaction and the generated steam is used to run a steam turbine. The vessel may include a temperature sensor for measuring the temperature that is connected to a control device.

According to embodiments of the invention, the vessel may include a stirring element. The stirring element may be used to stir the molten aluminum, thereby optimizing the reaction. The stirring may also distribute the bubbles within the aluminum, such that the total surface area of the bubbles and hence, their contact with the molten aluminum, may increase. Additionally, stirring may lengthen the path along which the bubbles travel through the aluminum and therefore, the reaction ratio may increase due to the stirring. The position of the stirring element and the rotation speed thereof is set so that it does not cause the bubbles to rise too quickly through the aluminum, i.e., before they have reacted optimally with the aluminum.

According to some embodiments the water inlet may include a unidirectional valve, designed so that the water or water vapor stream can enter the chamber while no matter from the chamber can flow back through the water inlet. The unidirectional valve may be located along a water or water vapor delivery pipe. In some embodiments that location would be adjacent to the water or water vapor inlet.

According to some embodiments a vaporizer is provided along the delivery pipe of the water, for vaporizing the water before it enters the chamber. A pump may be used to deliver the water or water vapor into the chamber. The pump may be located along the delivery pipe. Any appropriate pump may be used, including a low pressure pump, a high pressure injection system, which is either pulsed or continuous.

According to other embodiments, water is pumped into the chamber using a pump connected to the delivery pipe, and when water is introduced into the chamber, it is vaporized due to the high temperature prevailing within.

According to some embodiments of the invention, water or water vapor are introduced into the chamber through the nozzle. According to some embodiments, the nozzle may have single opening. For example, the opening may have an outlet diameter ranging from about 0.01 mm to 10 mm. According to other embodiments, the nozzle may have multiple openings, such as, for example, dosens, hundreds or thousands of openings. According to further embodiments of the invention, the nozzle may be made of any appropriate material, such as, for example, graphite, silicone nitrite and boron nitrite, as well as porous ceramic, alumina-silicate or silicon carbide. According to some embodiments, the nozzle may be made from a porous material such that the water vapor is introduced into the molten aluminum through the pores in the material. According to some embodiments, the vessel may contain a nozzle with a single outlet (e.g. about 1 mm in diameter), wherein the water or water vapor is introduced through the nozzle by a pump delivering from about 1 to 100 gram of water or water vapor per minute.

According to some embodiments, the hydrogen outlet may include a hydrogen release pipe. According to a further embodiment, the hydrogen outlet comprises a pressure controlled valve connected to the hydrogen release pipe, which lets the hydrogen out of the chamber only when the pressure thereof in the chamber is above a predefined pressure, therefore, the hydrogen is released in a hot and compressed form, since it heats up from the surrounding temperature in the vessel and is released only when the pressure thereof is above a certain value. According to further embodiments, the pressure at which the hydrogen is released is about 1.5-10 bar. According to some embodiments, the vessel may include a pressure sensor communicating with a control device.

According to one embodiment, the vessel may include an aluminum inlet, through which aluminum is delivered into the internal chamber. The aluminum inlet may include a unidirectional valve, ensuring that while aluminum enters the internal chamber, no matter from the chamber flows back. The aluminum inlet may be connected to an aluminum delivery pipe that connects to an aluminum reservoir. Aluminum may be fed from the aluminum reservoir into the chamber through the aluminum delivery pipe by a feeder, (e.g. a pump). The aluminum inlet may be positioned at a bottom region of the vessel. For example, the aluminum inlet may be positioned on the bottom wall of the vessel. According to other embodiments, the aluminum inlet may be positioned on a side wall of the vessel.

According to embodiments of the present invention, the vessel may include an oxide outlet, through which the alumina product is removed from the internal chamber. According embodiments of the present invention, the oxide outlet may include a pressure controlled valve. According to some embodiments of the present invention, the oxide outlet may be connected to an oxide removal pipe, preferably through a pressure controlled valve, and an oxide collection vessel. While removing the oxide from the vessel it is possible that a certain amount of aluminum will be removed also. However, additional aluminum may be added to the internal chamber through the aluminum inlet, and further, the removed aluminum may be recycled and reused as fuel according to any process known in the art, such as the Hall-Héroult process. The formed alumina is typically porous as some of the hydrogen generated by the reaction and residual water vapor may be trapped within the alumina due to the repetitive tearing and reforming of the alumina so that a layer of foamed alumina accumulates at the top region of the molten aluminum. According to an embodiment of the present invention, the alumina may be collected from the top region of the molten aluminum and may be recycled and therefore, the oxide outlet is positioned at the top region of the molten aluminum. According to some embodiments of the present invention, the oxide outlet it positioned close to the top level of the molten aluminum.

According to some embodiments of the present invention, the apparatus includes a control system that determines the action of any of the appropriate components, such as the temperature sensor, the pressure sensor, the stirrer, any of the valves, any of the pumps, etc.

According to some embodiments of the invention, the apparatus may include two or more internal chambers, wherein the water or water vapor bubbles are introduced into the first internal chamber, wherein they react with the molten aluminum to provide heat, hydrogen and excess water molecules. The hydrogen mixed with the excess water molecules may then be transferred into a second internal chamber, wherein the water molecules continue to react with the molten aluminum therein. According to such embodiments, the mixture of gases, i.e., hydrogen and water vapor, released from the last chamber is highly enriched in hydrogen.

According to further embodiments, the mixture of gases, i.e., hydrogen and excess water vapor, is released from an internal chamber and re-introduced into the same chamber, thus allowing more of the water molecules to react with the aluminum. The mixture of gases may be cycled any number of times through the chamber.

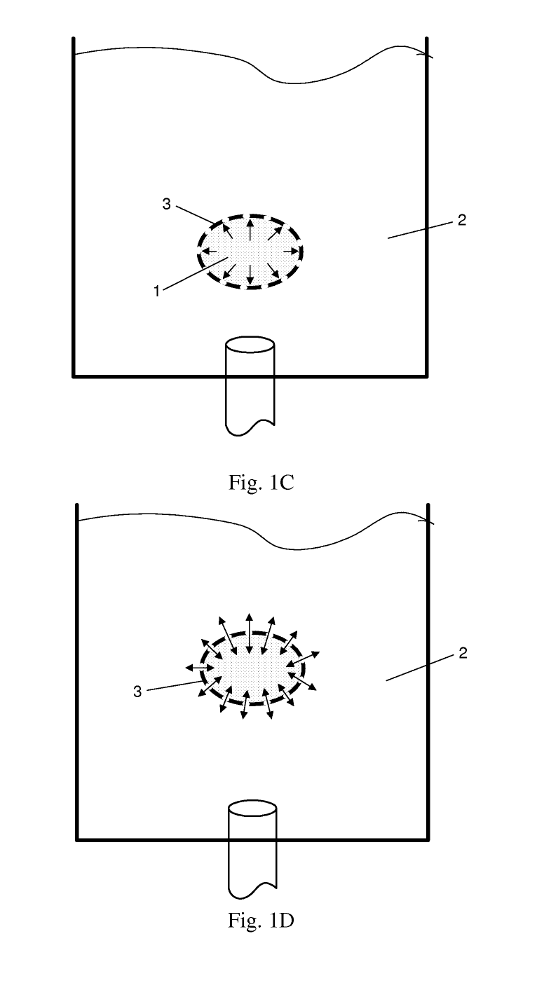

An embodiment of the apparatus of the present invention is shown in FIG. 2. The apparatus (100) includes internal chamber (132), water inlet (103) and hydrogen outlet (127). Water inlet (103) is connected to unidirectional valve (104), water delivery pipe (102), pump (510) and water reservoir (500). Molten aluminum (135) is placed in internal chamber (132) and water vapor bubbles or water droplets (not shown in figure) are pumped by pump (510) from water reservoir (500) through water delivery pipe (102) and unidirectional valve (104) into internal chamber (132). Once the water molecules enter internal chamber (132), they react with molten aluminum (135), generating hydrogen (not shown) that accumulates in gas collection volume (122) together with any unreacted water vapor that travels through the molten aluminum from water inlet (103) to gas collection volume (122). Once the pressure in gas collection volume (122) reaches a predefined value, the hydrogen and the unreacted water vapor exit through hydrogen outlet (127), via pressure controlled valve (136) and hydrogen removal pipe (128), connected on its other end to a hydrogen collection vessel (not shown in figure).

Apparatus (100) comprises cover (130), thermal insulation (120) and pressure vessel envelope (118). Cover (130) is hermetically sealed, excluding small openings (not shown) for equalizing pressure in gas collection volume (122) and pressure vessel envelope (118). Apparatus (100) additionally includes heating element (112), connected via heating power supply (108), to temperature controller (300).

As detailed above, the reaction between the water molecules and the aluminum produces porous alumina (134), which, as shown in FIG. 2, accumulates at the at the top of the molten aluminum (135).

An optional aluminum inlet (105) connected to chamber (132) is also shown in FIG. 2. Pump (410) pumps aluminum from aluminum container (400) through aluminum delivery pipe (106) and unidirectional valve (107) into chamber (132). Additionally, an optional oxide outlet (109) connected to chamber (132) is shown in FIG. 2. Alumina is removed from chamber (132) via oxide outlet (109) through valve (113) and oxide removal pipe (110) into oxide collection vessel (200). According to some embodiments, valve (113) is a pressure controlled valve. Apparatus (100), as shown in FIG. 2, includes additional optional components, i.e., stirrer (124) as well as temperature and pressure sensors (116). Sensors (116) are connected to a control system (not shown), which determines the flow rate through water inlet (103) and aluminum inlet (105). The control system may also determine the flow rate through hydrogen outlet (127) and oxide outlet (109). The control system may also determine the activation of heater (112) and speed of stirrer (124).

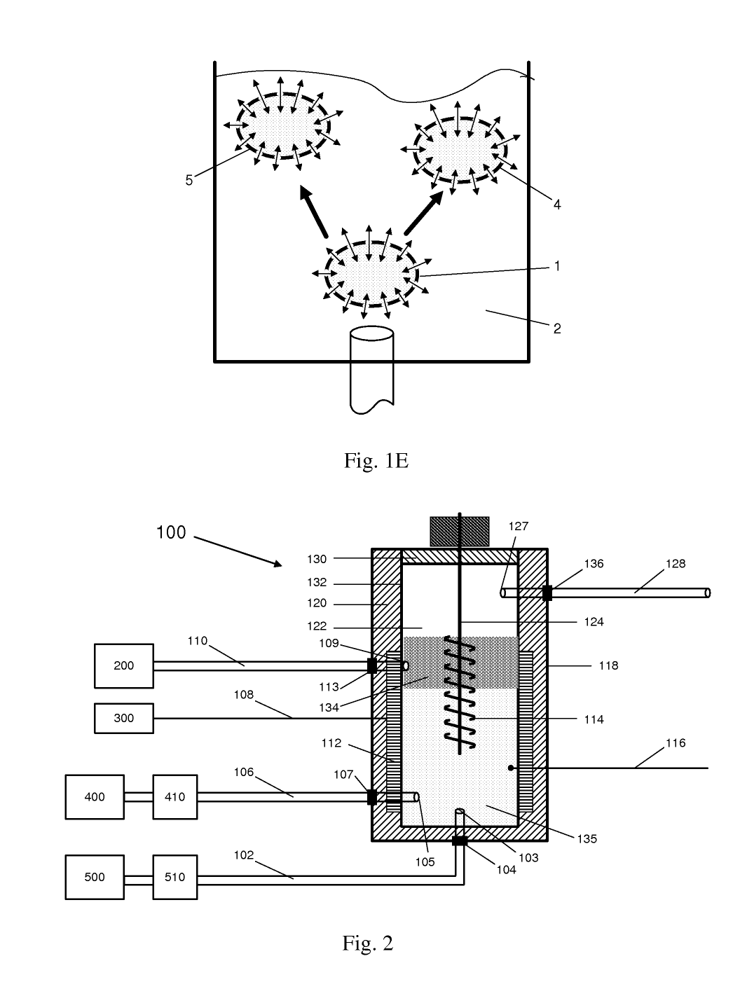

An embodiment of the apparatus of the present invention is shown in FIG. 3. The Apparatus (600) according to this embodiment is designed to include three adjacent vessels (618), (619) and (620), connected in series to one another by pipes (609) and (610). According to this embodiment, water bubbles are introduced into vessel (618) via pipe (608), where the react with the aluminum. The reaction between the water and the aluminum provides heat, hydrogen and excess water vapor. The hydrogen and excess water vapor are collected in region (615) and from there transferred through pipe (609) into the bottom region of vessel (619), where the remaining water molecules continue to react with the aluminum. The hydrogen and excess water vapor collected in region (616) of vessel (619) is transferred therefrom, via pipe (610) to vessel (620). The remaining water vapor in bubbles (650), which are enriched with hydrogen, reacts with aluminum (135) producing heat, alumina, which accumulates in layer (134) and additional hydrogen. The hydrogen, as well as any additional excess water vapor is collected in region (617), wherefrom it is released via hydrogen outlet (128).

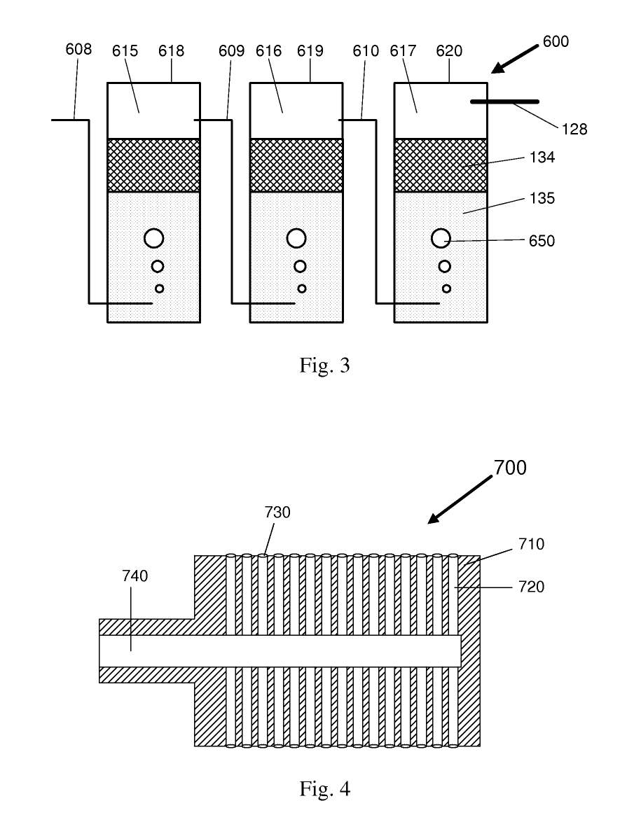

An embodiment of a nozzle (700) is shown in FIG. 4. Nozzle (700) may be used in water inlet (103), as shown in FIG. 2, for providing multiple streams of water bubbles into the vessel. Water or water vapor is provided through pipe (740). The stream of water or water vapor may flow from pipe (740) through smaller pipes (720) and exit through openings (730) into the aluminum in the vessel. Any appropriate material (710) may be provided to separate and hold pipes (720) in nozzle (700).

Some embodiments of present invention are directed to a method for reacting a high percentage of two materials without the need to implement high amounts of energy, wherein, under typical conditions, the two materials would not be able to react in such a high percentage without the implementation of high amounts of energy, due to the creation of a passivation layer between them. According to some embodiments, the first material may be brought into a liquid state and the other material into a gaseous state, wherein in such states the reaction between the two materials leads to the expansion of the gaseous material by means of heating or volume increase, such that the reaction leads to repeated tearing of the passivation barrier and to repeated cycles of reaction between the two materials.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for generating hydrogen comprising:
introducing water bubbles into a bottom region of a vessel containing molten aluminum allowing the water bubbles to rise within the molten aluminum, expanding as they rise; and
collecting hydrogen, generated in a reaction between the water bubbles and the molten aluminum, from the vessel.

2. The method according to claim 1, further comprising allowing the hydrogen to compress to a desired pressure level before it is collected.

3. The method according to claim 1, wherein the water bubbles comprise water vapor.

4. The method according to claim 1, further comprising reintroducing the collected hydrogen into the molten aluminum.

5. The method according to claim 1, wherein the molten aluminum is initially at a temperature of at least 650° C.

6. The method according to claim 1, wherein the water bubbles are initially at a temperature of at least 120° C.

7. An apparatus for generating hydrogen, said apparatus comprising:
a vessel having an internal chamber for containing molten aluminum;
at least one water inlet positioned at a bottom region of the vessel for introducing water bubbles into a bottom region of the chamber containing the molten aluminum allowing the water bubbles to rise within the molten aluminum, expanding as they rise;
at least one hydrogen outlet positioned at a top region of the vessel for collecting hydrogen generated in a reaction between the water bubbles and the molten aluminum, from the vessel;
a heating element, for heating aluminum in solid form disposed within the chamber so as to melt it into the molten aluminum.

8. The apparatus according to claim 7, wherein the water inlet is positioned at a bottom wall of the vessel.

9. The apparatus according to claim 7, wherein the hydrogen outlet is positioned at a top wall of the vessel.

10. The apparatus according to claim 7, wherein said at least one water inlet comprises a plurality of water inlets.

11. The apparatus according to claim 7, further comprising a cooling system.

12. The apparatus according to claim 11, wherein the cooling system is a water cooling system coupled with a steam turbine.

13. The apparatus according to claim 7, further comprising a heat sensor and a pressure sensor, which are connected to a control device.

14. The apparatus according to claim 7, further comprising a stirring element for stirring the molten aluminum.

15. The apparatus according to claim 7, further comprising an aluminum inlet for introducing aluminum into the chamber.

16. The apparatus according to claim 7, further comprising an oxide outlet for removing an oxide layer of alumina accumulated over the molten aluminum.

17. The apparatus according to claim 7, connected in series with one or more apparatii according to claim 7.

18. The apparatus according to claim 7, further a reintroduction facility for reintroducing the generated hydrogen into the molten aluminum.

19. An apparatus for generating hydrogen, said apparatus comprising:
a plurality of vessels, each vessel comprising:
an internal chamber for containing molten aluminum;
at least one water inlet positioned at a bottom region of the vessel for introducing water bubbles into a bottom region of the chamber containing the molten aluminum allowing the water bubbles to rise within the molten aluminum, expanding as they rise;
at least one hydrogen outlet positioned at a top region of the vessel for collecting hydrogen generated in a reaction between the water bubbles and the molten aluminum, from the vessel; and
a heating element, for heating aluminum in solid form disposed within the chamber so as to melt it into the molten aluminum;
wherein the plurality of vessels are connected in series by way of connecting said at least one hydrogen outlet of a vessel of the plurality of vessels to said at least one water inlet of an adjacent vessel of said plurality of vessels.
